(19) United States
(12) Patent Application Publication
(10) Pub. No.: US 2017/0146238 A1
(43) Pub. Date: May 25, 2017

(54) WASTE GAS TREATMENT DEVICE AND METHOD FOR TREATING WASTE GAS

(71) Applicants: ThyssenKrupp Industrial Solutions AG, Essen (DE); ThyssenKrupp AG, Essen (DE)

(72) Inventor: Timo Stender, Fröndenberg (DE)

(73) Assignees: ThyssenKrupp Industrial Solutions AG, Essen (DE); ThyssenKrupp AG, Essen (DE)

(21) Appl. No.: 15/316,397

(22) PCT Filed: Jun. 5, 2015
(86) PCT No.: PCT/EP2015/062574

§ 371 Date: Dec. 6, 2016

(30) Foreign Application Priority Data
Jun. 10, 2014 (DE) 10 2014 108 152.8

(51) Int. Cl. F23J 15/02; B01D 53/86; C04B 7/36

(52) U.S. Cl. CPC F23J 15/02; C04B 7/364; B01D 53/869; B01D 53/8656; B01D 53/8696; F23J 2219/10; B01D 2255/904

(57) ABSTRACT

An offgas treatment apparatus having a reduction catalyst and an oxidation catalyst downstream of the reduction catalyst may also include a temperature-affecting apparatus for the offgas positioned between the reduction catalyst and the oxidation catalyst. In some examples, the apparatus may include a second temperature-affecting apparatus for the offgas positioned upstream of the reduction catalyst. At least one of the first or second temperature affecting apparatuses may comprise a heat exchanger, a preheating apparatus, an auxiliary heater, or a mixing-in device for a fluid, for instance. In some examples, the apparatus may involve a dust filter positioned upstream of the reduction catalyst.

The invention relates to an offgas treatment apparatus and to a method of offgas treatment. The offgas treatment apparatus and the method can especially be employed within the production or processing of cement clinker, lime or minerals.

DE 197 20 205 A1 discloses a method of cleaning offgas laden with nitrogen oxides, in which the offgas is preheated in a heat exchanger, then reheated by means of a burner and subsequently supplied to a reduction catalyst with addition of a reducing agent. The hot offgases leaving the reduction catalyst are utilized to charge one of two heat storage means. During this time, the other heat storage means serves as heat exchanger for the offgas to be supplied to the reduction catalyst. As a result of cyclical switching of the two heat storage means, one of the heat storage means is thus always being charged, while the other heat storage means is being utilized as heat exchanger for preheating the offgas.

DE 197 20 205 A1 further discloses the possibility of a combination of the reduction catalyst with an oxidation catalyst downstream thereof, by means of which organic compounds and especially furans and dioxins are to be removed simultaneously from the offgas.

Proceeding from this prior art, it was an object of the invention to provide an offgas treatment apparatus which advantageously enables both reduction of nitrogen oxides and oxidation of carbonaceous compounds, such as carbon monoxide in particular, in offgases, especially flue gases. More particularly, the offgas treatment apparatus should be notable for higher oxidation rates for the carbonaceous compounds compared to the offgas treatment apparatus known from DE 197 20 205 A1.

This object is achieved by an offgas treatment apparatus as claimed in claim 1 and a method of offgas treatment as claimed in claim 15. Advantageous configurations of the offgas treatment apparatus of the invention and advantageous embodiments of the method of the invention are the subject of the further claims and are apparent from the description of the invention which follows.

The invention is based on the finding that a temperature of at least 400° C. is advantageous for particularly high oxidation rates in an oxidation catalyst. However, this temperature is generally already too high for a reduction catalyst. The basic idea of the invention is therefore to supply the offgas to be treated to the catalysts connected in series with the optimal temperature as far as possible for each of these. For this purpose, means of (actively) affecting the temperature of the offgas are provided at least between the oxidation catalyst and the reduction catalyst. Since the temperature of the offgas in the reduction catalyst should be lower than in the downstream oxidation catalyst, it is preferable that these means take the form of a preheating apparatus and heat the offgas after the treatment in the reduction catalyst and before the treatment in the oxidation catalyst.

Accordingly, a generic offgas treatment apparatus comprising at least one reduction catalyst (preferably with a metering apparatus for a reducing agent arranged upstream thereof based on the offgas stream) and an oxidation catalyst downstream of the reduction catalyst (in flow direction of the offgas) is characterized in accordance with the invention in that a (first) temperature-affecting apparatus, especially preheating apparatus, for the offgas is arranged between the reduction catalyst and the oxidation catalyst.

In a corresponding method of offgas treatment in which the offgas is guided through a reduction catalyst and then an oxidation catalyst, in accordance with the invention, the temperature of the offgas is (actively) affected after the treatment in the reduction catalyst and before the treatment in the oxidation catalyst and, more particularly, the offgas is heated.

For achievement of high oxidation rates, it may advantageously be the case that the offgas, before the treatment in the oxidation catalyst, is heated to a temperature between 250° C. and 650° C., preferably between 300° C. and 500° C. and more preferably between 350° C. and 450° C.

In an additionally preferred configuration of the offgas treatment apparatus of the invention, it is also possible for a second temperature-affecting apparatus arranged upstream of the reduction catalyst, especially preheating apparatus, for the offgas to be provided.

The method of the invention may accordingly provide for affecting of the temperature, especially heating, of the offgas before the treatment in the reduction catalyst.

In order to achieve high lowering rates in the reduction catalyst for nitrogen oxides in particular, it may advantageously be the case that the offgas, before the treatment in the reduction catalyst, is heated to a temperature between 160° C. and 440° C., preferably between 180° C. and 380° C. and more preferably between 200° C. and 350° C.

In an advantageous configuration of the first and/or second temperature-affecting apparatus, it may be the case that it/they comprise(s) a heat exchanger. In this case, the heat exchanger may especially have a regenerative design, such that the heat energy transferred to the offgas in the heat exchanger is at least partly waste heat. Another option is to generate the heat energy transferred to the offgas in the preheater at least partly for this purpose (only). For this purpose, the first and/or second temperature-affecting apparatus may, for example, comprise an auxiliary heater (i.e. an apparatus for generation of heat, especially by combustion of a fuel, with the primary or exclusive aim of introducing heat into the offgas), mixing-in of gases, in which fuels can be combusted for generation of heat energy. In addition, the function of the temperature-affecting apparatus can also be based on mixing-in of a fluid, especially of a gas, with another, especially higher, temperature compared to the local temperature of the offgas. For this purpose, the temperature-affecting apparatus may comprise mixing-in devices for a fluid, especially a gas (for example another offgas or a cooling gas).

The integration of a heat exchanger into the first and/or second temperature-affecting apparatus may especially enable utilization of the heat energy still present in the offgas downstream of the oxidation catalyst for the preheating of the offgas prior to the entry thereof into the reduction catalyst and/or the oxidation catalyst and corresponding partial transfer thereof in the heat exchanger(s). It is advantageously also possible to utilize the heat energy generated as a result of an exothermic oxidation in the oxidation catalyst.

Alternatively or additionally, it may also be the case that heat is transferred in the heat exchanger from another medium (other than the offgas already treated).

The medium may especially be a fluid and especially a fluid stream. Such a fluid stream may especially be utilized or generated in a plant for mechanical and/or thermal processing of a material in which the offgas treatment apparatus of the invention is used. This plant may, for example, be a plant for cement clinker production. This plant may comprise a kiln, for example a rotary kiln, for burning of the cement clinker, a material preheater upstream of the kiln in the direction of material flow (here in that case the cement raw meal) and/or a clinker cooler downstream of the kiln in the direction of material flow (here in that case the cement clinker) and/or devices for removal of substreams of media, especially gases, for example bypass installations. The fluid stream utilized in the heat exchanger(s) of the offgas treatment apparatus of the invention may in that case, for example, be all or a substream of the offgas stream which is utilized for preheating of the cement raw meal in the material preheater and originates from the kiln. The fluid stream may also be heated cooling air that has partly (“cooler middle air”) or substantially fully (“cooler waste air”) passed through the clinker cooler. It is also possible to branch off offgas originating from the kiln prior to entry into the material preheater and utilize it in the heat exchanger(s) of the offgas treatment apparatus of the invention for heat exchange with the offgas to be supplied to the reduction catalyst and the oxidation catalyst. In addition, it is also possible to utilize an offgas or waste air from another part of the plant, for example a drying plant (with or without additional firing).

Heat transfer from the medium to the offgas to be preheated may be direct (optionally through a dividing wall) or indirect with an intermediate transfer medium (especially liquid, gaseous or a mixture of the two).

The medium may also be that material which, when processed, gives rise to the offgas to be treated by means of the offgas treatment apparatus of the invention. In a plant for cement clinker production, the medium may especially be cement raw meal, which is preferably preheated in a material preheater by the offgas originating from the kiln of the plant. In that case, the offgas to be treated may also be the offgas to be treated. In that case, the material preheater may be at least part of the first and/or second temperature-affecting apparatus, but especially of the second temperature-affecting apparatus, of the offgas treatment apparatus of the invention, in which case the preheating function for the offgas to be treated can be achieved by cooling the offgas by heat transfer to the material in the material preheater to a reduced degree if required, especially to only a relatively minor degree, than is envisaged in other operating states of the plant and especially than is enabled by maximum heat transfer performance of the material preheater.

For this purpose, it may preferably be the case that the heat exchanger of the offgas treatment apparatus of the invention (or the material preheater of the plant) comprises one or more heat exchanger stages, in which case a first feed for the material stream, based on the flow direction of the material stream through the heat exchanger, is arranged beyond one heat exchanger stage and a second feed for the material stream, based on the direction of flow of the material through the heat exchanger, is arranged upstream of this heat exchanger stage, and a control unit for division of the material stream as required between the first feed and the second feed is provided. Depending on what proportion of the material to be preheated passes through which and how many heat exchanger stages, the heat transfer from the offgas to the material and hence the (residual) temperature of the offgas can be adjusted.

The heat exchanger stage that can be (partly) bypassed by the material to be preheated if required is preferably that which the material passes through first as it passes through the heat exchanger (or material preheater). This can achieve the effect that the heat exchange from the offgas to the material proceeds primarily in the heat exchanger stage(s) closer to the processing apparatus (especially the (rotary) kiln). This can have a positive effect on pressure drops in the heat exchanger (or material preheater). Additionally preferably, the heat exchanger (or material preheater) may take the form of a cyclone preheater having multiple stages (for example four, five or six stages), the construction and mode of function of which are common knowledge.

The heat exchanger of the offgas treatment apparatus of the invention may further comprise a heat storage means, such that the temperature is affected, and there is especially preheating of the offgas that enters the reduction catalyst or the oxidation catalyst through heat exchange with a heat storage medium.

It may especially be the case here that the first and/or second temperature-affecting apparatus comprises/each comprise at least two heat storage means through which the offgas to be supplied either to the oxidation catalyst or the reduction catalyst flows in alternation, in order to preheat it, or through which offgas that has left the oxidation catalyst flows in order to absorb heat energy therefrom. As a result, a portion of the heat energy of the offgas that has already left the oxidation catalyst is consequently utilized to preheat the offgas which enters the reduction catalyst or the oxidation catalyst. This especially enables regenerative utilization of heat energy which is released as a result of exothermic oxidation in the oxidation catalyst.

Since it may especially be envisaged in accordance with the invention to preheat the offgas entering the reduction catalyst to a lower temperature than the offgas entering the oxidation catalyst, it may further be the case, if both the first and the second temperature-affecting apparatus each comprise at least one and preferably at least two heat storage means, that the offgas leaving the oxidation catalyst first flows through the heat storage means assigned to the oxidation catalyst and then through the heat storage means assigned to the reduction catalyst, in order to “charge” them. Other ways of connecting the heat storage means, especially in parallel, in the offgas stream are also possible.

Heat storage means advantageously suitable for use in the offgas treatment apparatus of the invention have been found to be heat storage means comprising a ceramic heat storage material.

Especially when heat transfer necessary for the attainment of a target temperature range for the offgas entering the reduction catalyst or the oxidation catalyst is not achievable completely by heat exchange with the offgas already treated or another medium, it may be the case that this target temperature range is attained by auxiliary heating, i.e. generation of heat with the exclusive or at least primary aim of introducing heat energy into the offgas. For this purpose, the first and/or second preheating apparatus of the offgas treatment apparatus of the invention may comprise an appropriate auxiliary heater. The generation of heat energy in the auxiliary heater may especially be based on combustion of a fuel, although other, for example electrical, means of generating heat may also be provided. The fuel used for such an auxiliary heater may especially be readily and rapidly combustible fuels such as, in particular, gases (e.g. natural gas), mineral oil and/or coal.

In a further-preferred configuration of the offgas treatment apparatus of the invention, a dust filter may also be provided, which separates dust (i.e. especially solid particles having a mean grain size of between 3μm and 10 μm) from the offgas. The dust filter may preferably be connected upstream of the reduction catalyst (in flow direction of the offgas), in order to avoid contamination of the reduction catalyst and the oxidation catalyst with the dust, which could lead to quicker deactivation thereof. The provision of a dust filter may be advantageous especially when the dust loading of the offgas (upstream of the dust filter) is normally at least 30 g/m³ (i.e. in the normal state or under standard conditions).

The offgas treatment apparatus of the invention and/or a performance of the method of the invention are especially suitable for the cleaning of offgas (flue gas) which arises in the production and/or processing of raw materials, especially raw materials in the coal and steel industry and/or in power plant technology for generation of energy. A particularly advantageous field of use is the cleaning of offgas (flue gas) which arises in the production and/or processing of raw materials in the form of cement, lime and/or minerals.

It is possible here, especially for provision of heat energy for preheating of the offgas, for plants or plant components that do not serve for treatment of a raw material also comprise. More particularly, for a temperature-affecting apparatus in the form of a mixing-in device or a heat exchanger, it is possible to utilize a component and especially a material or fluid stream included in the component from a plant or apparatus for a different use, for example in the power plant industry (especially combustion of materials (especially raw materials, but also, for example, waste) for generation of electrical energy in particular). These plants or apparatuses for a different use may, for example, also serve for drying, torrefaction and/or pyrolysis of a carbonaceous material or fluid stream in particular.

The use of indeterminate articles (“a”), especially in the claims and the part of the description that elucidates them, should be understood as such and not construed to mean “one”. Such a use should thus be understood such that at least one of the elements identified thereby is present and more than one may be present.

The invention is elucidated in detail hereinafter with reference to working examples illustrated in the drawings. The drawings show:

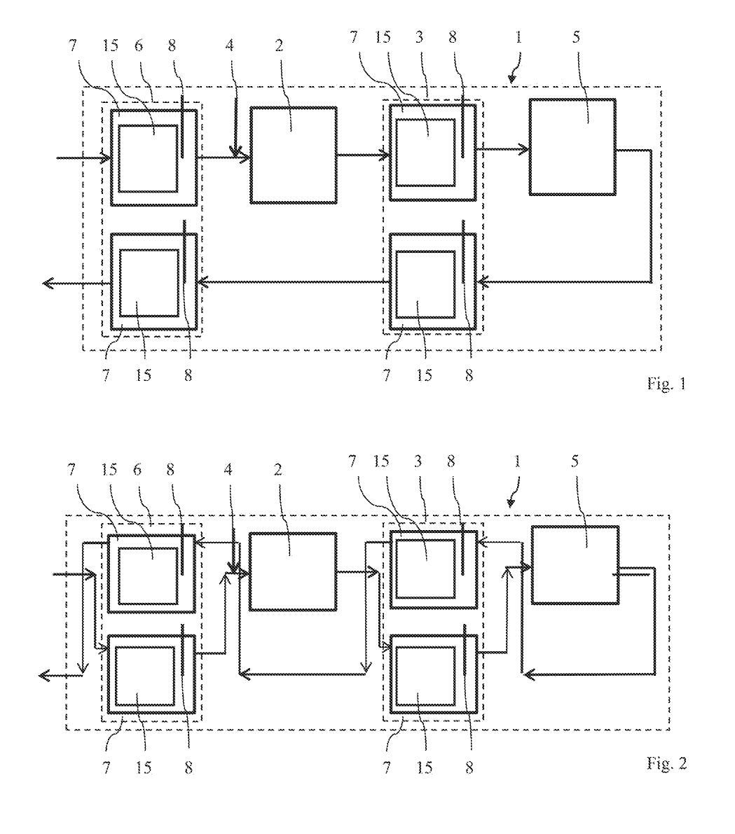

FIG. 1: in a schematic view, an offgas treatment apparatus of the invention in a first mode of connection;

FIG. 2: the offgas treatment apparatus according to FIG. 1 in a second mode of connection; and

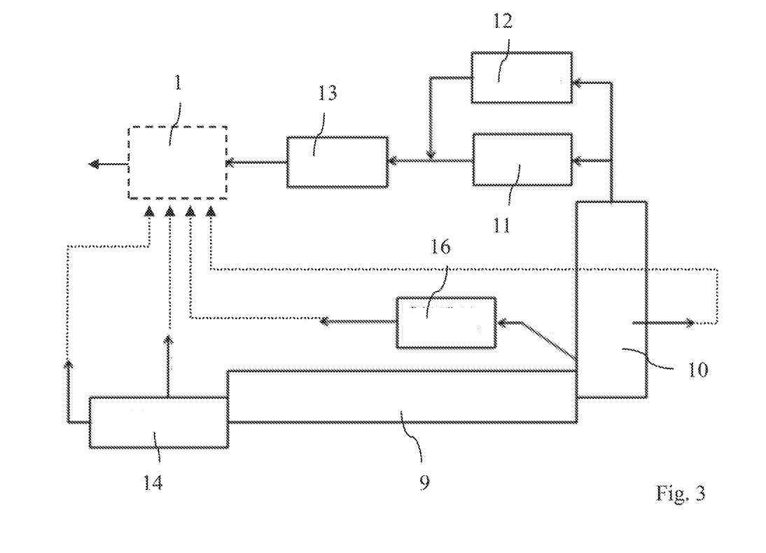

FIG. 3: a plant for burning cement clinker comprising an offgas treatment apparatus of the invention.

FIGS. 1 and 2 show, in schematic form, an embodiment of an inventive offgas treatment apparatus 1 as may be used especially for treatment of offgas originating from a processing apparatus for mechanical and/or thermal processing of inorganic material, for example a (rotary) kiln for burning cement clinker.

The offgas treatment apparatus 1 comprises an oxidation catalyst 5 and a first preheating apparatus 3 assigned to the oxidation catalyst 5, a reduction catalyst 2, a second preheating apparatus 6 assigned to the reduction catalyst 2 for the offgas, and a metering apparatus 4 for a reducing agent arranged between the second preheating apparatus 6 and the reduction catalyst 2. The oxidation catalyst 5 is arranged beyond the reduction catalyst 2 in flow direction of the offgas. This is associated with the advantage that the reduction catalyst 2 can act as a “filter” or “guard” for the oxidation catalyst 5 with respect to particular pollutants (for example sulfur, alkalis, heavy metals). This is because these pollutants cause only a slight decrease in activity, if any, in the reduction catalyst 2, but would, without filtering by the reduction catalyst 2, lead to a significant decrease in activity of the oxidation catalyst 5.

Each of the preheating apparatuses 3, 6 comprises two heat exchangers 7, one of which in each case, by the offgas, is arranged directly before entry into the catalyst assigned in each case and the other in flow direction beyond the oxidation catalyst 5. This connection of the two heat storage means 7 of each of the preheating apparatuses 3, 6 can be switched over, as shown in the two FIGS. 1 and 2.

The heat exchangers 7 each comprise a ceramic heat storage material 15 which features a high heat capacity. The heat storage means 7 through which the offgas leaving the oxidation catalyst 5 flows are heated by the offgas and remove heat energy therefrom as a result. This heat energy is (for the most part) intermediately stored. By switching over the heat storage means 7 of the two preheating apparatuses 3, 6, it is then possible to integrate the two heat storage means charged by the offgas leaving the oxidation catalyst 5 into the stream of the offgas entering the catalyst assigned in each case, as a result of which the intermediately stored heat energy is partly transferred to the respective offgas stream and leads to the envisaged preheating of the offgas. In this context, the heat transfer from the offgas downstream of the oxidation catalyst 5 to the offgas upstream of the oxidation catalyst 5 (and partly also upstream of the reduction catalyst 2) which is achievable by means of the preheating apparatuses 3, 6 is based on the generation of heat energy by the exothermic oxidation of, in particular, carbon monoxide (CO) and organic hydrocarbons which proceeds in the oxidation catalyst 5 according to the following reaction equations:

2CO+O₂→2CO₂;

CₙHₘ+(n+m/4)O₂→nCO₂+m/2H₂O.

In the reduction catalyst 2, by contrast, there is reduction of nitrogen oxides (NOx) and especially of nitrogen monoxide (NO) in conjunction with the aqueous ammonia solution introduced into the offgas as reducing agent via the metering apparatus 4 according to the following reaction equation:

4NO+4NH₃+O₂→4N₂+6H₂O.

For maximum lowering rates of nitrogen oxides in the reduction catalyst on the one hand and carbon monoxide and hydrocarbons in the oxidation catalyst on the other hand, different temperatures of the offgas in the respective catalysts are envisaged. For example, a temperature of the offgas supplied to the offgas treatment apparatus 1 at, for example, about 150° C. on entry into the reduction catalyst 2 of about 240° C. may be optimal, whereas the offgas on entry into the oxidation catalyst 5 should have a temperature of about 380° C. The particular temperature increase is achieved by preheating of the offgas before entry into the reduction catalyst 2 by means of the second preheating apparatus 6 and before entry into the oxidation catalyst 5 by means of the first preheating apparatus 3. As a result of the difference in the temperatures of the offgas to be established for the reduction catalyst 2 on the one hand and the oxidation catalyst 5 on the other hand, it may advantageously be the case that the offgas leaving the oxidation catalyst 5 flows first through the heat exchanger 7 of the first preheating apparatus 3 which has just been connected accordingly and then, i.e. in the already more cooled-down state (at, for example, about 240° C.), through the heat exchanger 7 of the second preheating apparatus 6 which has just been connected accordingly (which the offgas then leaves again at, for example, about 150° C.).

Very exact attainment of the offgas temperatures to be established for the two catalysts can be achieved firstly via a corresponding design of the heat exchangers 7 of the preheating apparatuses 3, 6. At the same time, the heat transfer from the offgas to the heat storage means 7 downstream of the oxidation catalyst 5 and from the heat storage means 7 to the offgas upstream of the oxidation catalyst 5 (and in the second preheating apparatus 6 also upstream of the reduction catalyst 2) can be affected, for example, by the volumes of the respective heat storage materials 15, the sizes of the contact areas between the heat storage materials 15 and the offgas and/or the mean flow rate of the offgas through the heat storage materials 15.

On the other hand, for very exact attainment of the offgas temperatures to be established for the two catalysts, it may also be the case that the offgas is additionally preheated at the appropriate point if required by means of an auxiliary heater 8 in each case, in which a fuel, for example natural gas, mineral oil or coal can be combusted in order to generate heat energy. These auxiliary heaters 8 are actuated by a closed-loop control apparatus (not shown) which controls the additional generation of heat by means of the auxiliary heaters 8 as a function of the (target) offgas temperature envisaged in each case.

Preheating of the offgas upstream of the reduction catalyst 2 and between the reduction catalyst 2 and the oxidation catalyst 5 can be achieved, as an alternative or in addition to regenerative utilization of heat energy which is removed from the offgas treated itself, also by heat exchange with another medium, especially a fluid flow and more preferably a gas flow. Various options for this purpose are shown in FIG. 3.

FIG. 3 shows the integration of an inventive offgas treatment apparatus 1 into a plant for burning cement clinker. The plant comprises, as well as the offgas treatment apparatus 1, a rotary kiln 9 in which finely ground cement raw meal which has been preheated beforehand in a material preheater 10 in countercurrent by offgas leaving the rotary kiln 9 is burnt to give cement clinker. The offgas leaving the material preheater 10 then either flows through a cooling tower 11 or is utilized at least partly in a raw mill 12 for drying the cement raw meal in the course of grinding. Subsequently, the offgas is dedusted in a dust filter 13 and sent to the offgas treatment in the offgas treatment apparatus 1. In addition, the plant also comprises a clinker cooler 14 in which the cement clinker discharged from the rotary kiln 9 is cooled by means of cooling air.

FIG. 3 shows, by the dotted arrows, that it is possible, for example, to branch off a substream of the offgas directly upstream of, directly downstream of or from the material preheater 10 itself and—optionally after pretreatment by means of a pretreatment apparatus 16—utilize it to preheat the offgas flowing through the offgas treatment apparatus 1. It is likewise possible to correspondingly utilize the cooling air from the clinker cooler 14, in which case branching-off is possible either before or after complete flow through the clinker cooler 14, which affects the temperature of the cooling air and hence the possible heat transfer to the offgas flowing through the offgas treatment apparatus 1.

### REFERENCE NUMERALS

1. offgas treatment apparatus
2. reduction catalyst
3. first preheating apparatus
4. metering apparatus for a reducing agent
5. oxidation catalyst
6. second preheating apparatus
7. heat exchanger
8. auxiliary heater
9. rotary kiln
10. material preheater
11. cooling tower
12. raw mill
13. dust filter
14. clinker cooler
15. ceramic heat storage material
16. pretreatment apparatus

1.-19. (canceled)

20. An offgas treatment apparatus comprising:
a reduction catalyst;
an oxidation catalyst positioned downstream of the reduction catalyst; and
a first temperature-affecting apparatus for the offgas positioned between the reduction catalyst and the oxidation catalyst.

21. The offgas treatment apparatus of claim 20 further comprising a second temperature-affecting apparatus for the offgas positioned upstream of the reduction catalyst.

22. The offgas treatment apparatus of claim 21 wherein at least one of the first temperature-affecting apparatus or the second temperature-affecting apparatus is a preheating apparatus.

23. The offgas treatment apparatus of claim 21 wherein at least one of the first temperature-affecting apparatus or the second temperature-affecting apparatus comprises an auxiliary heater.

24. The offgas treatment apparatus of claim 21 wherein at least one of the first temperature-affecting apparatus or the second temperature-affecting apparatus comprises a mixing-in device for a fluid.

25. The offgas treatment apparatus of claim 21 wherein at least one of the first temperature-affecting apparatus or the second temperature-affecting apparatus comprises a heat exchanger.

26. The offgas treatment apparatus of claim 25 wherein there is heat transfer from the offgas downstream of the oxidation catalyst in the heat exchanger.

27. The offgas treatment apparatus of claim 26 wherein there is heat transfer from a medium in addition to the offgas in the heat exchanger.

28. The offgas treatment apparatus of claim 27 wherein based on a direction of flow of the medium through the heat exchanger a first feed for the medium is positioned beyond a heat exchanger stage, wherein based on the direction of flow of the medium through the heat exchanger a second feed for the medium is positioned upstream of the heat exchanger stage, wherein the heat exchanger comprises a control unit for dividing the medium between the first and second feeds.

29. The offgas treatment apparatus of claim 25 wherein the heat exchanger comprises a heat storage means.

30. The offgas treatment apparatus of claim 29 wherein at least one of the first temperature-affecting apparatus or the second temperature-affecting apparatus comprises at least two heat storage means through which
the offgas to be supplied to either the oxidation or reduction catalysts flows in alternation to be preheated, or
the offgas that has left the oxidation catalyst flows to absorb heat energy.

31. The offgas treatment apparatus of claim 29 wherein the heat storage means comprises a ceramic heat storage material.

32. The offgas treatment apparatus of claim 20 further comprising a dust filter positioned upstream of the reduction catalyst.

33. The offgas treatment apparatus of claim 20 further comprising a metering device for a reducing agent positioned upstream of the reduction catalyst.

34. A method for treating offgas, the method comprising:
guiding the offgas through a reduction catalyst;
changing a temperature of the offgas after the offgas is treated in the reduction catalyst; and
guiding the offgas through an oxidation catalyst after the temperature of the offgas is changed.

35. The method of claim 34 wherein the changing the temperature of the offgas comprises heating the offgas before treatment in the oxidation catalyst to a temperature of between 250° C. and 650° C.

36. The method of claim 34 further comprising changing a temperature of the offgas before the offgas is treated in the reduction catalyst.

37. The method of claim 36 wherein the changing the temperature of the offgas before the offgas is treated in the reduction catalyst comprises heating the offgas to a temperature of between 160° C. and 380° C.

38. The method of claim 34 further comprising employing the offgas when producing or processing raw materials.
